(19) United States
(12) Patent Application Publication
(10) Pub. No.: US 2009/0086572 A1
(43) Pub. Date: Apr. 2, 2009

(54) MICRODEVICE AND FLUID MIXING METHOD

(75) Inventors: Yoshiyuki Miyoshi, Minami-Ashigara-shi (JP); Takayuki Fujiwara, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/237,443

(22) Filed: Sep. 25, 2008

(30) Foreign Application Priority Data
Sep. 28, 2007 (JP) 2007-256760

(51) Int. Cl. B01J 19/00; B01F 15/02

(52) U.S. Cl. 366/181.6; 422/224

(57) ABSTRACT

In a microdevice in which a plurality of fluids respectively passing through a separate introduction channel are merged in a merging section in a micro space to mix the fluids and the mixed fluids are discharged from the merging section via a discharge channel, a tip section of each of the introduction channels comprises a tapered contraction section so as to contract a flow of fluid, the introduction channels are disposed so that central axes of the introduction channels do not intersect at one point each other, and the merging section is formed of a space surrounded with edges of the contraction sections of respective introduction channels. Thereby, reacting fluids can be mixed rapidly each other, and contamination of air bubbles into the whole fluid can be suppressed by narrowing a dead space of a discharge channel immediately after the merging section.

### BACKGROUND OF THE INVENTION

1. Field of the Invention

The present invention relates to a microdevice and a fluid mixing method. More particularly, it relates to a microdevice and a fluid mixing method in which a plurality of fluids are caused to pass through respectively separate supply channels and flow together into a mixing field, by which mixing (including a reaction by mixing) of the fluids each other is carried out.

2. Description of the Related Art

Recently, so-called a microdevice or a microreactor for allowing fluids to react or to mix each other while controlling precisely in a minute space attracts attention. In the microreactor, a specific surface area increases by means of scale down and as a result, migration of molecules is achieved only by diffusion. Accordingly, it is possible to precisely control collisions among the molecules.

Further, there is two steps reaction process which includes, for example, all the molecules are allowed to react in the first step and an aggregation of the reacting molecules is suppressed in the second step. In this case, it is necessary to complete the mixing instantly in the first step. However, because a velocity component in a perpendicular direction with respect to a mainstream direction depends only on molecular diffusion in the conventional microreactor, it was difficult to treat such a reaction.

Then, as one device for mixing plural kinds of fluid effectively, for example, Japanese Patent Application Publication No. 2006-167600 proposes a micromixer which supplies the fluids into a mixing vessel in such a manner as for generating a swirling flow in the mixing vessel.

Also, “Chemical Micro Process Engineering”, V. Hesseletal, WILEY-VCH Verlag GmbH & Co. KGaA proposes a cyclone mixer providing a plurality of nozzles in order to inject the fluids into a merging section.

### SUMMARY OF THE INVENTION

However, the micromixer described in Japanese Patent Application Publication No. 2006-167600 has the structure whose mixing section is provided with a power unit such as an actuator, and there were problems of increasing in cost for the device, or of aggravation of reaction control property caused by scale-up of the mixing section. Also, because it was necessary for the cyclone mixer described in “Chemical Micro Process Engineering” to design a large merging section, a shear force working among the fluids each other becomes weak and as a result, it was difficult to convert the kinetic energy possessed by the fluid into a circuitous energy effectively.

The present invention has been made in view of the above situation, and accordingly an object of the present invention is to provide a microdevice and a fluid mixing method both capable of allowing reacting fluids to mix rapidly each other by generating a swirling flow in the merging fluids at a merging section, and suppressing contamination of air bubbles into the whole fluid by narrowing a dead space of a discharge channel immediately after the merging section. Moreover, at the same time, the present invention provides the microdevice reducing cost to be spent for the device.

To achieve the above object, a first aspect of the present invention provides a microdevice in which a plurality of fluids respectively passing through a separate introduction channel are merged in a merging section in a micro space to mix the fluids and the mixed fluids are discharged from the merging section via a discharge channel, wherein a tip section of each of the introduction channels comprises a contraction section which is tapered on at least one face or on opposed faces at different angles so as to contract a flow of fluid, the introduction channels are disposed so that central axes of the introduction channels do not intersect at one point each other, and the merging section is formed of a space surrounded with edges of the contraction sections of respective introduction channels.

According to the first aspect of the present invention, because the respective introduction channels are disposed so that the central axes (cores) of the introduction channels do not intersect at one point, a high shear force can be applied between the fluids at the merging section. Accordingly, the kinetic energy spent for collision is efficiently converted to the circuitous energy and causes a swirling flow, thereby enables to generate a velocity component in the direction perpendicular to the direction of the mainstream of the fluid. Therefore, the reactive fluids can be allowed to mix efficiently each other.

In addition, because a tip section of the flow introduction channel has a contraction section which is tapered to contract the flow of the fluid, the velocity of the fluids can be raised at the contraction section, and the swirling flow (rotational flow) can be strengthened. Furthermore, because the merging section is formed of a space surrounded with edges of the contraction sections of respective introduction channels, it makes a contact condition between the fluids favorable. In addition, because it is possible to mix the fluids in a narrow space, a uniform and rapid mixing can be carried out.

Additionally in the present invention, although the explanation is made about mixing fluids in the merging section, reaction by mixing can be included, and the same applies to the following.

According to a second aspect of the present invention, in the microdevice according to the first aspect, angles θ₁ and θ₂ between perpendicular lines with respect to a flow direction of the fluid in said contraction section and tapered portions satisfy the following equation:

20(°)≦180(°)−θ₁−θ₂≦70(°) (A)

θ₁, θ₂≦90(°) (B)

According to a third aspect of the present invention, in the microdevice according to the second aspect, at least one of the θ₁ and θ₂ is 90 degrees.

The second aspect and the third aspect of the present invention define the angle of the tapered portions at the contraction section. Setting the angles between perpendicular lines with respect to a flow direction of the fluid in the contraction section and the tapered portions within the above range can generate the swirling flow more efficiently. In particular, setting at least one of the θ₁ and θ₂ as 90 degrees is particularly preferable because a pressure loss in the contraction section can be reduced.

According to a fourth aspect of the present invention, in the microdevice according to any one of the first to third aspects, the number of the introduction channels is two, and the central axis of each introduction channel deviates by not smaller than 20% but not larger than 40% with respect to a width of the introduction channels.

According to the fourth aspect of the present invention, each introduction channel is formed such that the central axis of each introduction channel deviates from a line when the central axes are coincident with each other by not smaller than 20% but not larger than 40% with respect to the width of the introduction channel. Therefore, a contact area where introduction channels contact with each other can be reduced. Accordingly, the central axes in the contraction section can be deviated, and the swirling flow becomes easy to occur. In addition, because it is possible to mix the fluids within a narrow portion between the introduction channels, a contact condition of respective fluids can be made favorable.

According to a fifth aspect of the present invention, in the microdevice according to any one of the first to fourth aspects of the present invention, viscosity of the fluid supplied from the introduction channel is not larger than 30 cp.

According to the fifth aspect of the present invention, because the viscosity of the fluid is not larger than 30 cp, the generated swirling flow will allow the reacting fluids to rapidly mix each other.

According to a sixth aspect of the present invention in the microdevice according to any one of the first to fifth aspects of the present invention, flow rate of the fluid supplied from the introduction channel is not less than 1 cc/min but not larger than 1000 cc/min.

According to the sixth aspect of the present invention, because the flow rate of the fluid supplied from the introduction channel is not less than 1 cc/min but not larger than 1000 cc/min, it becomes possible to easily mix the fluids having passed through each introduction channel at the merging section.

To achieve the foregoing object, a seventh aspect of the present invention provides a fluid mixing method in which a plurality of fluids respectively passing through a separate introduction channel are merged in a merging section in a micro space to mix the fluids and the mixed fluid are discharged from the merging section via a discharge channel, the method including: a flow contraction step for contracting each of the fluids having passed through the introduction channels, just before merging the fluids together at the merging section; a merging step for mixing the fluids each other while generating a swirling flow so that central axes of the introduction channels do not intersect at one point each other; and a flow discharge step for discharging the mixed fluids from the merging section.

The seventh aspect constitutes the present invention as a fluid mixing method. According to the seventh aspect of the present invention, the same effects as the first aspect of the present invention can be achieved.

According to the present invention, by disposing respective introduction channels such that central axes of the introduction channels do not intersect at one point each other, it become possible to generate a swirling flow using kinetic energy held by fluids. Accordingly, because it is possible to generate a velocity component in the direction perpendicular to a direction of the mainstream of the fluid, reacting fluids are allowed to rapidly mix each other. Since the fluids are mixed by generating the swirling flow, the dead space in a discharge channel can be reduced and contamination of bubbles into the fluids can be suppressed. Further, because the swirling flow can be generated by disposing the central axes of the introduction channels so as not to intersect at one point, the manufacturing cost of the device can be reduced.

### BRIEF DESCRIPTION OF THE DRAWINGS

FIG. 1A is a front view of T-shaped microdevice;

FIG. 1B is a plan view of T-shaped microdevice;

FIG. 1C is an exploded schematic view of a merging section;

FIG. 2 is a perspective view of T-shaped microdevice shown in FIG. 1;

FIG. 3A is a front view of Y-shaped microdevice;

FIG. 3B is a plan view of Y-shaped microdevice;

FIG. 4 is a plan view of a microdevice which mixes four kinds of fluid;

FIG. 5 is a perspective view of the microdevice shown in FIG. 4;

FIG. 6 is a plan view of a microdevice which mixes five kinds of fluid;

FIGS. 7A and 7B are graphs explaining a simulation result (change in Mass fraction); and

FIG. 8 is a graph explaining a simulation result (degree of variation).

### DETAILED DESCRIPTION OF THE PREFERRED EMBODIMENTS

Preferred embodiments of the microdevices and the methods for mixing fluids in accordance with the present invention will now be described in detail with reference to the accompanying drawings.

### 1) T-shaped and Y-shaped Microdevices

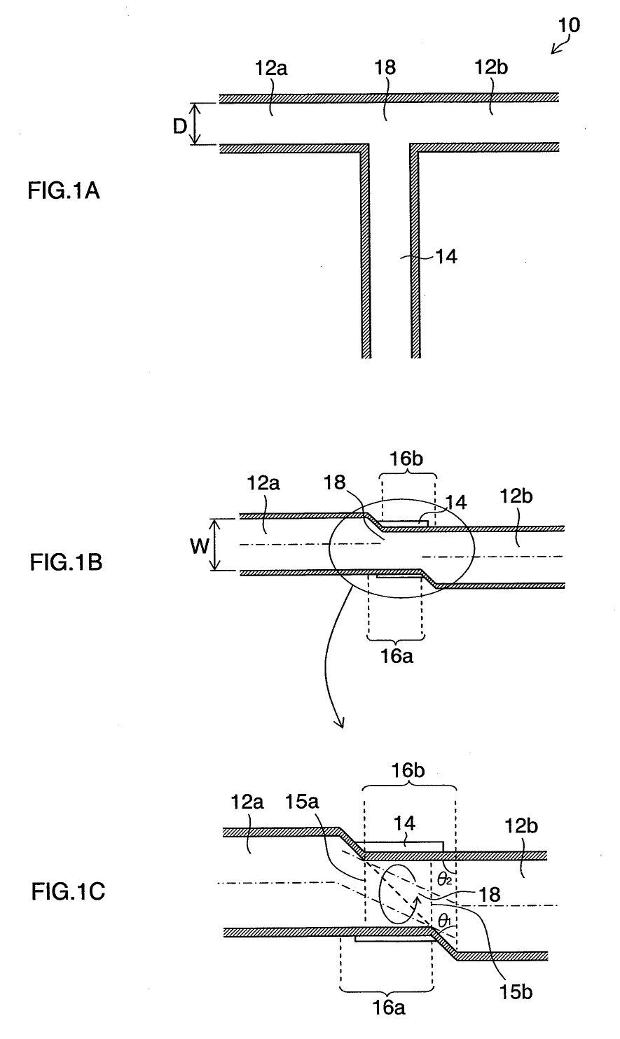

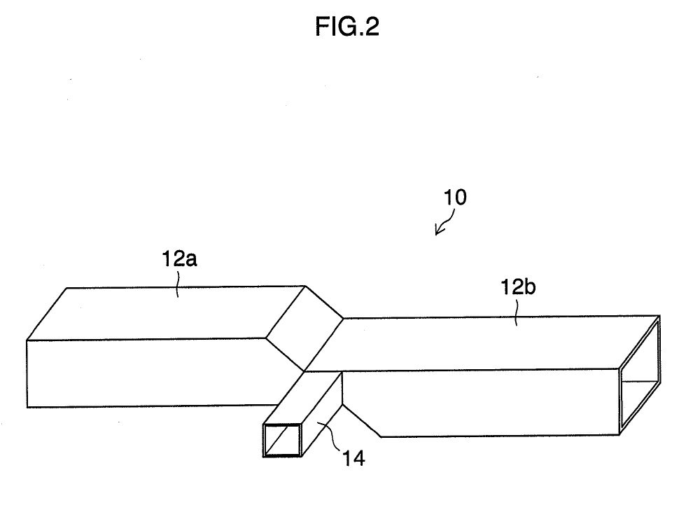

As one embodiment of the microdevices of the present invention, FIGS. 1A, 1B and 1C illustrate a front view, a plan view and an exploded schematic view of its merging section of a T-shaped microdevice, respectively. Also, FIG. 2 illustrates a perspective view of the T-shaped microdevice viewing from the discharge channel 14.

As shown in FIGS. 1A, 1B, 1C and 2, the T-shaped microdevice 10 includes introduction channels 12a, 12b and a discharge channel 14. Further, introduction channels 12a and 12b have contraction sections 16a and 16b whose cross sectional areas of the channels are reduced as shown in FIG. 1A; and also have a merging section 18 formed with a space surrounded with edges (or end portion) 15a and 15b for contraction sections that are shown in FIG. 1C. In the contraction sections 16a and 16b, the edges 15a and 15b for the contraction section correspond to inlets with respect to the merging section 18 formed by a side contacting with another contraction section and a side facing with it. As shown in FIG. 1C and FIG. 2, central axes of the introduction channels 12a and 12b are disposed so as not to intersect each other with the relation of deviating in the width direction of the channels. By making the central axes to deviate (to be eccentric) each other, it will become possible that the kinetic energy spent for collision in the merging section is positively converted to the circuitous energy. Accordingly, because it is possible to generate a velocity component in the direction (arrow direction in FIG. 1C) perpendicular with respect to the direction of the mainstream of the fluid in the discharge channel 14, the fluids can be allowed to mix rapidly each other. In the case where the central axes of the introduction channels intersect each other at one point, the kinetic energy cannot be converted efficiently into the circuitous energy because the fluids collide directly each other. Further, in order to obtain the swirling flow, a contact area between the edge of the contraction section and the merging section should be smaller than the cross sectional area of the merging section 18 and as a result, it is necessary to enlarge the merging section. In the present invention, a desired performance can be obtained even though the cross sectional area of the merging section is equal to the contact area between the contraction section and the merging section.

The contraction section 16a is formed by tapering, with different angle, in at least one face or an opposing face in the introduction channel 12a. By providing the tapering to form the contraction section 16a, and by hastening the velocity of the fluids at the contraction section 16a, the kinetic energy can be increased.

In FIG. 1B, although one face is tapered, it is possible that both of the opposing faces have tapered shapes. However, when both of the opposing faces have the tapered shapes, the tapered shapes is formed so that the angles θ₁ and θ₂ between perpendicular lines with respect to a flow direction of the fluid and the tapered shaped become different angles each other. When the angles θ₁ and θ₂ are the same, it is probable that the central axis of one introduction channel and the central axis of the other introduction channel will intersect each other, and in this case, it is not preferable because the energy is spent in collision between the fluids.

The θ₁ and θ₂ between perpendicular lines with respect to a flow direction of the fluid in the contraction section and tapered shapes preferably satisfy the following relation:

20(°)≧180−θ₁−θ₂≦70(°) (A)

θ₁, θ₂≦90(°) (B)

Further, it is preferable that the expression (A) is not smaller than 30 degrees and not larger than 60 degrees. By keeping the expression (A) within the above range, the kinetic energy can be efficiently converted into the circuitous energy and it becomes possible to generate a swirling flow.

Further, it is preferable that at least one of the θ₁ and θ₂ is 90 degrees. By settling at least one of them to be 90 degrees, a pressure loss at the contraction section 16a can be reduced and resultantly it becomes possible to hasten the velocity of the fluid.

The merging section 18 is formed by the space surrounded with edges 15a and 15b of the contraction section of the introduction channels 12a and 12b, and is a place where the fluids having passed through the introduction channels 12a and 12b are allowed to merge each other. The fluid that passed through the introduction channel 12a and the contraction section 16a advances toward downside in FIG. 1C. On the contrary, the fluid having passed through the introduction channel 12b and the contraction section 16b advances toward upside of the drawing. Accordingly, the swirling flow occurs in the arrow direction at the merging section 18 on which the contraction sections 16a and 16b merge together and resultantly, it becomes possible that the fluids are allowed to mix rapidly each other. Also, because generating the swirling flow at the merging section 18 can reduce the dead space that may appear at the junction between the merging section 18 and the discharge channel 14, any bubble contamination into the fluid can be prevented.

In the case of T-shaped microdevice shown in FIG. 1, the respective introduction channels 12a and 12b are disposed so that their central axes before the contraction section are deviated from each other as shown in FIG. 1C and FIG. 2. It is preferable for the deviation of the central axes that they deviate from each other is not smaller than 20% but not larger than 40% with respect to the width of the respective introduction channels, from the line when the central axes of the introduction channels 12a and 12b coincide with each other.

The mixed fluids after merging at the merging section 18 will be discharged via the discharge channel 14. In this occasion, because the swirling flow that occurred at the merging section 18 flows into the discharge channel 14 while circulating in the arrow direction of FIG. 1C, it is possible to promote the mixing of the fluids.

It is preferable for the channel size used for the microdevice of the present invention that the equivalent diameter of the introduction channel 12 or the discharge channel 14 is constituted to be not longer than 1000 μm for the purpose of precisely controlling the reaction while mixing rapidly. Further, because the swirling flow occurs at the merging section 18, it is better for the depth D of the introduction channel 12 to be shorter than the width W of it, and is more preferably not longer than ½ of the width W. Furthermore, in order for quickly discharging the fluid mixed at the merging section 18, the diameter of the discharge channel 14 is preferably not shorter than the equivalent diameter of the merging section 18 and not longer than 1000 μm.

Additionally, although the cross sectional shapes of the introduction channel 12 and the discharge channel 14 are quadrangles in FIG. 1, various shapes may be employable without particularly limited to FIG. 1. In particular, it is preferable for the discharge channel 14 that it has a cross sectional shape of round in order for efficiently conveying the swirling flow from the merging section 18. By making the discharge channel 14 into round cross sectional shape, the above-mentioned dead space can be reduced.

Although the fluid used for the microdevice of the present invention is not particularly limited, it is preferable that the microdevice is used with the flow rate of the fluid in the range of 1 to 1,000 cc/min. Further, it is preferable for the fluid to be of low viscosity from the viewpoint of a pressure loss, and specifically, the fluid with the viscosity of not more than 30 cp is favorable. Regarding with the kind of the fluid, specifically appropriate examples include water; acid solutions; alkaline solutions; organic solvents such as methanol, ethanol or dimethylsulfoxide; or a mixed solution of those; and further, a dispersion liquid prepared by dispersing fine particles into the foregoing liquid or the mixed solution. The fine particles are referred as particles having diameters of not longer than 1 μm herein.

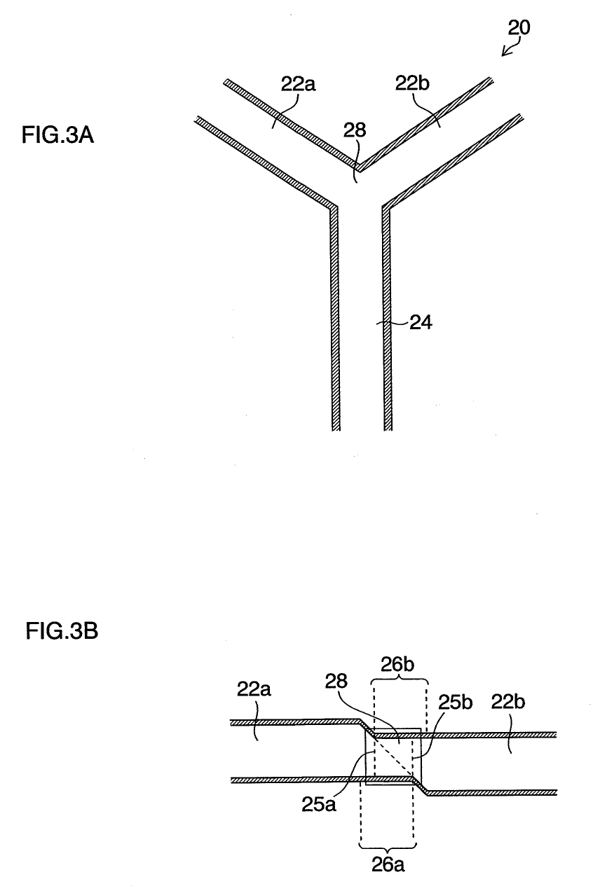

FIG. 3A is a front view of Y-shaped microdevice and FIG. 3B is a plan view of Y-shaped microdevice. Similarly with T-shaped microdevice, in Y-shaped microdevice as shown in FIG. 3B, by deviating the introduction channels 22a and 22b in the perpendicular direction with respect to the flow direction of the fluid in the discharge channel 24, the swirling flow can be generated in the perpendicular direction with respect to the flow direction of the fluid in the discharge channel 24, thereby allowing the reacting fluids to mix rapidly each other.

### 2) A Mixing Type Microdevice for Mixing Fluids of Three Kinds or More

Next, an explanation about the microdevice for mixing fluids of three kinds or more will be attempted. Even when the number of the introduction channels is not less than 3, inhibiting the central axes of the introduction channels from intersecting each other will enable to generate the swirling flow at the merging section and the fluids can be allowed to mix rapidly each other.

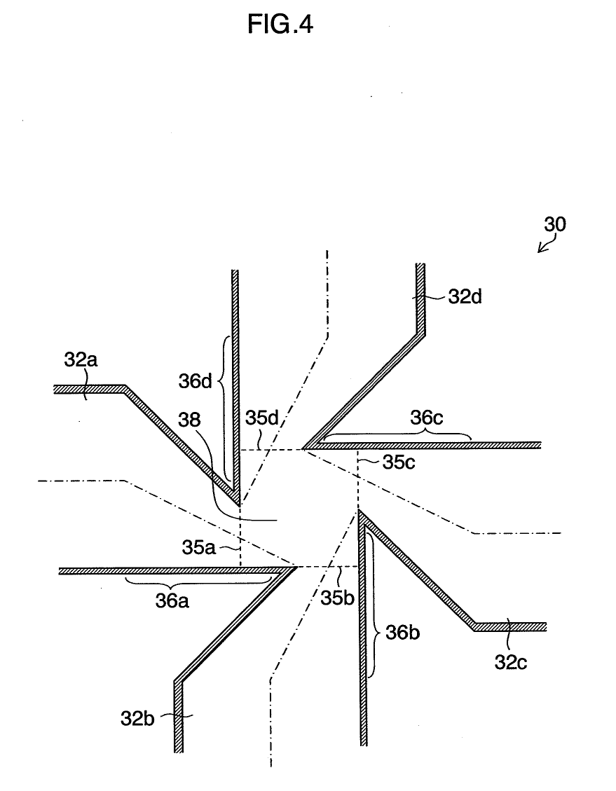

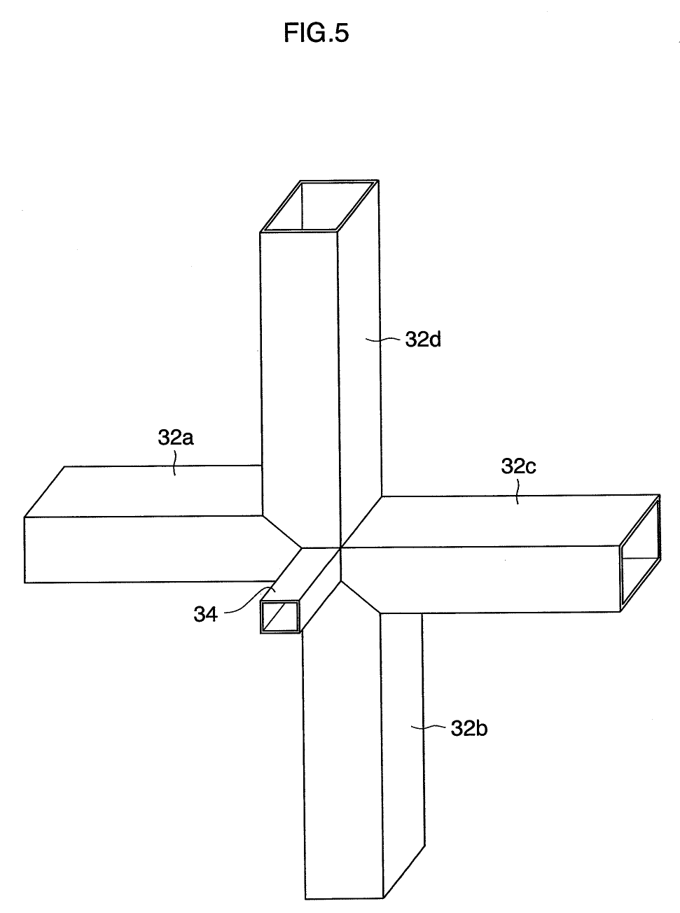

FIG. 4 is a plan view of a microdevice which mixes four kinds of fluid, and FIG. 5 is a perspective view of the microdevice shown in FIG. 4, overviewing from the discharge channel 34. When the number of the introduction channels is 4, the fluids are flown from the introduction channels 32a, 32b, 32c and 32d in a perpendicular direction with respect to the flow direction of the fluids in the discharge channel 34 as shown in FIG. 5. Respective introduction channels are disposed such that the central axes of facing introduction channels never intersect each other. Thereby, an energy loss by collision can be reduced and the kinetic energy can be efficiently converted into the circuitous energy.

Also, the merging section 38 is formed with a space surrounded with the edges 35a 35b, 35c, and 35d each other of the contraction sections 36a, 36b, 36c, and 36d. The edges 35a to 35d of the contraction sections are, similarly with the case of two introduction channels, inlets into the merging section 18 for the fluids formed by the sides facing each other from other contraction sections and the sides contacting with them in the contraction sections 36a to 36d. By designing the merging section 38 into such a constitution, the swirling flow can be generated with the fluids having passed through the separate introduction channels from each other.

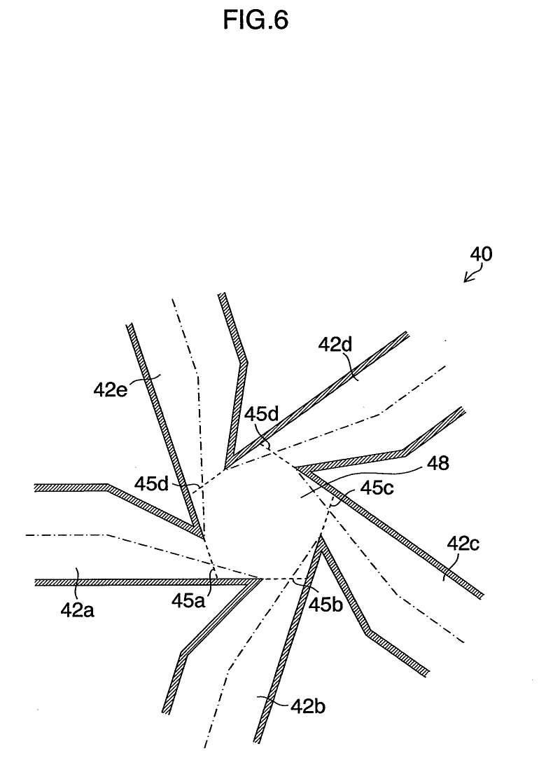

FIG. 6 illustrates a plan view of a microdevice which mixes five kinds of fluid. Even when the number of the introduction channels 42 is 5, a similar constitution will enable to generate the swirling flow effectively at the merging section 44.

Effects of the present invention will be explained by means of the simulation in the following.

The simulation was conducted with the use of T-type microdevice having two introduction channels 12a and 12b, and one discharge channel 14, which are shown in FIG. 1. The size of the introduction channel was quadrangle-shaped channel of 500×500 μm, and the comparison of a usual T-shaped microdevice (conventional type) with a microdevice (the present invention) whose central axes of the introduction channels were deviated in the length of ±100 μm was carried out.

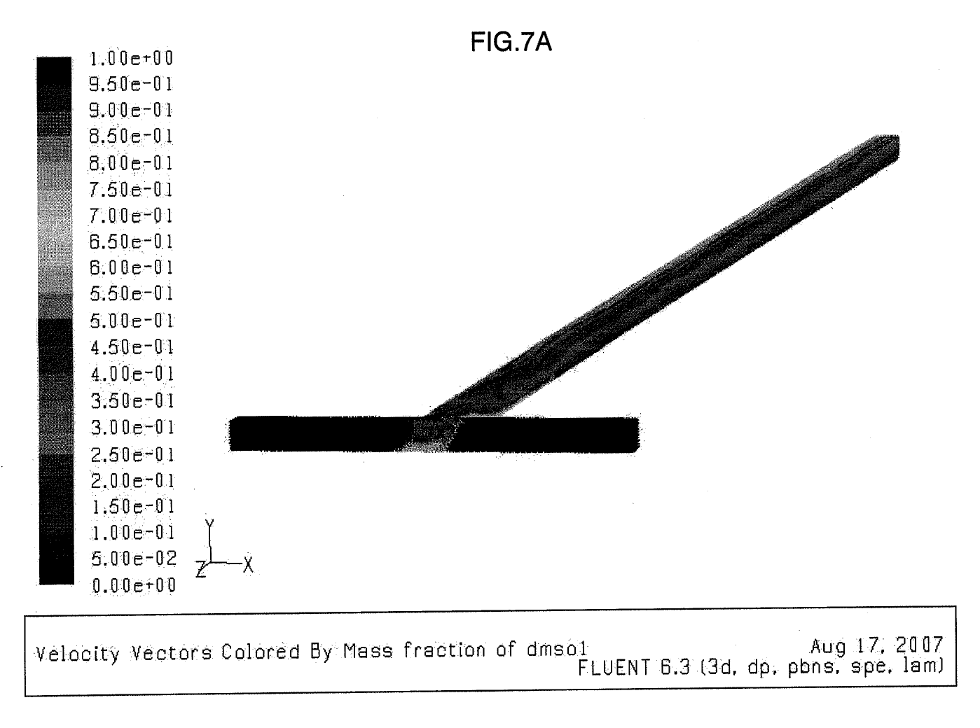

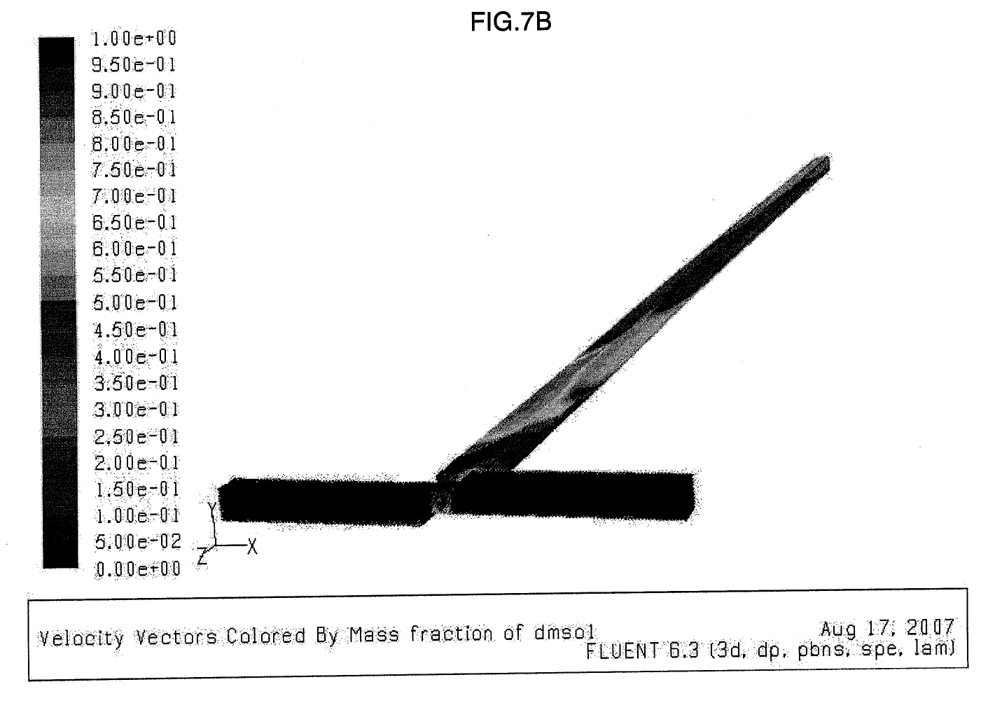

Dimethylsulfoxide (DMSO) was used as the fluid and the flow rate was 50 cc/min. A simulation result measured about the change in mass fraction of DMSO passed through one introduction channel 12a is shown in FIGS. 7A and 7B.

FIG. 7A is a result by using the conventional microdevice, and FIG. 7B is a result by using the microdevice of the present invention. From FIG. 7B, it is verified that by using the microdevices of the present invention, the swirling flow appears and the mass fraction of the fluid varies helically.

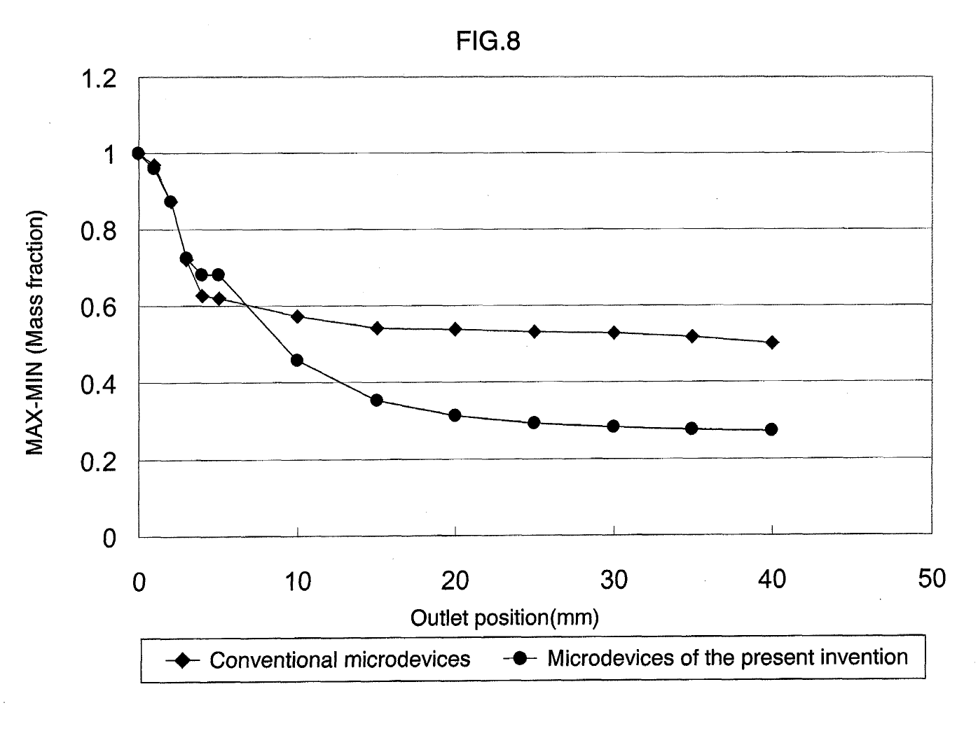

Further, FIG. 8 illustrates the degree of variation (maximum value-minimum value) evaluated in mass fraction of DMSO passed through the introduction channel 12a as a degree of mixing. When it is completely mixed, the value of the degree of mixing will become zero. Because there is a portion where it is uneasy for the fluids to be mixed at the wall surface of the discharge channel 14, the degree of variation (maximum value-minimum value) does not become zero, however, it is verified that the mixing property became favorable comparing with the conventional microdevices.

What is claimed is:

1. A microdevice in which a plurality of fluids respectively passing through a separate introduction channel are merged in a merging section in a micro space to mix the fluids and the mixed fluids are discharged from the merging section via a discharge channel, wherein
a tip section of each of the introduction channels comprises a contraction section which is tapered on at least one face or on opposed faces at different angles so as to contract a flow of fluid,
the introduction channels are disposed so that central axes of the introduction channels do not intersect at one point each other, and
the merging section is formed of a space surrounded with edges of the contraction sections of respective introduction channels.

2. The microdevice according to claim 1, wherein
angles θ₁ and θ₂ between perpendicular lines with respect to a flow direction of the fluid in said contraction section and tapered portions satisfy the following equation:
20(°)≦180(°)−θ₁−θ₂≦70(°) (A)
θ₁, θ₂≦90(0) (B)

3. The microdevice according to claim 2, wherein
at least one of said θ₁ and θ₂ is 90 degrees.

4. The microdevice according to claim 1, wherein
the number of the introduction channels is two, and
the central axis of each introduction channel deviates by not smaller than 20% but not larger than 40% with respect to a width of the introduction channels.

5. The microdevice according to claim 1, wherein
viscosity of the fluid supplied from the introduction channel is not larger than 30 cp.

6. The microdevice according to claim 1, wherein
flow rate of the fluid supplied from the introduction channel is not less than 1 cc/min but not larger than 1000 cc/min.

7. A fluid mixing method in which a plurality of fluids respectively passing through a separate introduction channel are merged in a merging section in a micro space to mix the fluids and the mixed fluid are discharged from the merging section via a discharge channel, the method comprising:
a flow contraction step for contracting each of the fluids having passed through the introduction channels, just before merging the fluids together at the merging section;
a merging step for mixing the fluids each other while generating a swirling flow so that central axes of the introduction channels do not intersect at one point each other; and
a flow discharge step for discharging the mixed fluids from the merging section.
